(19) United States
(12) Patent Application Publication
(10) Pub. No.: US 2023/0420753 A1
(43) Pub. Date: Dec. 28, 2023

(54) SYSTEMS AND METHODS FOR INFLUENCING BATTERY CELL CYCLE LIFE BY VARYING COMPRESSION FORCE

(71) Applicant: FORD GLOBAL TECHNOLOGIES, LLC, Dearborn, MI (US)

(72) Inventors: Minghong LIU, Northville, MI (US); Kent SNYDER, Dearborn, MI (US)

(21) Appl. No.: 17/846,141

(22) Filed: Jun. 22, 2022

(51) Int. Cl. H01M 10/44; B60L 53/62

(52) U.S. Cl. CPC H01M 10/44; B60L 53/62; H01M 2220/20

(57) ABSTRACT

Battery charging systems and methods are disclosed for influencing battery cell cycle life by varying a compression force applied to the battery cells during charging events. An exemplary battery charging system may include a battery array, a compression device configured to apply a compression force to the battery array during a charging event, and a control module. The control module may be programmed to control the compression device to apply a first compression force during a low charging rate condition and to apply a second, different compression force during a high charging rate condition

### TECHNICAL FIELD

This disclosure relates to battery charging systems and methods for influencing battery cell cycle life by varying a compression force applied to the battery cells during charging events.

### BACKGROUND

A traction battery pack typically powers an electric machine and other electrical loads of an electrified vehicle. The traction battery pack includes a plurality of battery cells that must be periodically recharged to replenish the energy necessary to power these loads. Charging at relatively high charging rates can reduce the cycle life of battery cells.

### SUMMARY

A battery charging system according to an exemplary aspect of the present disclosure includes, among other things, a battery array, a compression device configured to apply a compression force to the battery array during a charging event, and a control module programmed to control the compression device to apply a first compression force during a low charging rate condition and to apply a second, different compression force during a high charging rate condition.

In a further non-limiting embodiment of the foregoing battery charging system, the low charging rate condition includes a Level 1 or Level 2 charging condition, and the high charging rate condition includes a DC fast charging condition.

In a further non-limiting embodiment of either of the foregoing battery charging systems, the second, different compression force is a larger compression force than the first compression force.

In a further non-limiting embodiment of any of the foregoing battery charging systems, the second, different compression force is a smaller compression force than the first compression force.

In a further non-limiting embodiment of any of the foregoing battery charging systems, the compression device includes an air bladder.

In a further non-limiting embodiment of any of the foregoing battery charging systems, the compression device includes an air cylinder or a hydraulic cylinder.

In a further non-limiting embodiment of any of the foregoing battery charging systems, the compression device includes a motor actuated threaded shaft rod.

In a further non-limiting embodiment of any of the foregoing battery charging systems, the compression device includes a shape memory alloy structure.

In a further non-limiting embodiment of any of the foregoing battery charging systems, a sensor system is operably coupled to the control module and configured to monitor a charge rate during the charging event.

In a further non-limiting embodiment of any of the foregoing battery charging systems, the control module is a component of an electrified vehicle that includes the battery charging system.

In a further non-limiting embodiment of any of the foregoing battery charging systems, the control module is a component of an electric vehicle supply equipment (EVSE) system.

In a further non-limiting embodiment of any of the foregoing battery charging systems, the first compression force and the second compression force are different forces and are each in the range of about 5 psi to about 15,000 psi.

A method according to another exemplary aspect of the present disclosure includes, among other things, varying a compression force applied to a battery array of a traction battery pack during a charging event. Varying the compression force incudes applying a first compression force during a low charging rate condition and applying a second, different compression force during a high charging rate condition.

In a further non-limiting embodiment of the foregoing method, the low charging rate condition includes a Level 1 or Level 2 charging condition, and the high charging rate condition includes a DC fast charging condition.

In a further non-limiting embodiment of either of the foregoing methods, the second, different compression force is a larger compression force than the first compression force.

In a further non-limiting embodiment of any of the foregoing methods, the second, different compression force is a smaller compression force than the first compression force.

In a further non-limiting embodiment of any of the foregoing methods, varying the compression force includes inflating or deflating an air bladder of a compression device.

In a further non-limiting embodiment of any of the foregoing methods, varying the compression force includes extending or retracting a piston of an air cylinder or a hydraulic cylinder of a compression device.

In a further non-limiting embodiment of any of the foregoing methods, varying the compression force includes rotating a screw shaft rod of a compression device.

In a further non-limiting embodiment of any of the foregoing methods, varying the compression force includes altering a shape of a shape memory alloy structure of a compression device.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates an electrified vehicle operably connected to an electric vehicle supply equipment (EVSE) system.

FIG. 2 schematically illustrates an exemplary battery charging

system.

FIG. 3 schematically illustrates a method of controlling the battery charging system of FIG. 2 during a charging event.

FIG. 4 schematically illustrates another exemplary battery charging

system.

FIG. 5 schematically illustrates a compression device of the battery charging system of FIG. 4.

FIG. 6 schematically illustrates another exemplary battery charging system.

FIG. 7 schematically illustrates another exemplary battery charging system.

FIG. 8 schematically illustrates another exemplary battery charging system.

FIG. 9 schematically illustrates another exemplary battery charging system.

FIG. 10 schematically illustrates another exemplary battery charging system.

FIG. 11 schematically illustrates another exemplary battery charging system.

FIG. 12 schematically illustrates another exemplary battery charging system.

FIG. 13 schematically illustrates another exemplary battery charging system.

FIG. 14 schematically illustrates another exemplary battery charging system.

### DETAILED DESCRIPTION

This disclosure describes battery charging systems and methods for influencing battery cell cycle life by varying a compression force applied to the battery cells during charging events. An exemplary battery charging system may include a battery array, a compression device configured to apply a compression force to the battery array during a charging event, and a control module. The control module may be programmed to control the compression device to apply a first compression force during a low charging rate condition and to apply a second, different compression force during a high charging rate condition. These and other features of this disclosure are discussed in greater detail in the following paragraphs of this detailed description.

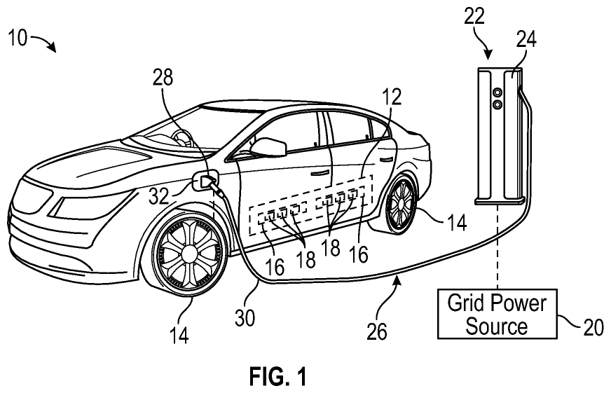

FIG. 1 illustrates an exemplary electrified vehicle 10 that includes a traction battery pack 12. The electrified vehicle 10 may include any electrified powertrain capable of applying a torque from an electric machine for providing motive power for driving drive wheels 14 (or other traction devices) of the electrified vehicle 10. In an embodiment, the electrified vehicle 10 is a plug-in hybrid electric vehicle (PHEV). In another embodiment, the electrified vehicle is a battery electric vehicle (BEV). Therefore, the powertrain of the electrified vehicle 10 may electrically propel the drive wheels 14 either with or without the assistance of an internal combustion engine.

The electrified vehicle 10 of FIG. 1 is schematically illustrated as a car. However, the teachings of this disclosure may be applicable to any type of vehicle, including but not limited to, cars, trucks, vans, sport utility vehicles (SUVs), airplanes, boats, buses, drones, etc.

Although shown schematically, the traction battery pack 12 may be a high voltage traction battery pack that includes a plurality of battery arrays 16 (e.g., battery assemblies or groupings of battery cells 18) capable of outputting electrical power to one or more electric machines (e.g., electric motors) of the electrified vehicle 10. In an embodiment, the battery cells 18 are lithium-ion battery cells. However, other types of energy storage devices and/or output devices can also be used to electrically power the electrified vehicle 10.

The battery cells 18 of the traction battery pack 12 may periodically require charging for replenishing their energy levels. The electrified vehicle 10 may therefore interface with a grid power source 20 (e.g., AC power, solar power, wind power, or combinations thereof) through an electric vehicle supply equipment (EVSE) system 22 in order to transfer energy from the grid power source 20 to the electrified vehicle 10 for charging the traction battery pack 12.

The EVSE system 22 may include an EVSE housing 24 and a charge cord assembly 26. The EVSE housing 24 may be configured as a wall box, a charging station stanchion, etc. The specific configuration of the EVSE housing 24 is not intended to limit this disclosure. The EVSE housing 24 may include the necessary equipment (e.g., relays, human machine interfaces, etc.) for coordinating the transfer of energy between the electrified vehicle 10 and the grid power source 20.

The charge cord assembly 26 may include a charge coupler 28 and a cable 30. The cable 30 may be connected at one end to the charge coupler 28 and at an opposite end to the EVSE housing 24. The charge coupler 28 may be coupled (e.g., plugged-in) to a charge port assembly 32 (sometimes referred to as a vehicle inlet assembly) of the electrified vehicle 10 in order to transfer energy from the grid power source 20 to the electrified vehicle 10.

In an embodiment, the charge coupler 28 is configured to plug into an SAE J1772 type charge port assembly 32. However, other charge coupler/charge port configurations are further contemplated within the scope of this disclosure. The specific configurations of the charge coupler 28 and the charge port assembly 32 are therefore not intended to limit this disclosure.

The EVSE system 22 and the electrified vehicle 10 may be configured to provide any level of charging (e.g., Level 1 AC charging, Level 2 AC charging, DC fast charging, etc.). In general, Level 1 charging refers to charging events in which power levels of less than about 2.4 kW are delivered for charging the battery cells 18 of the traction battery pack 12, and Level 2 charging refers to charging events in which power levels of between about 3 kW and about 20 kW are delivered for charging the battery cells 18 of the traction battery pack 12. Both Level 1 and Level 2 charging are typically delivered using an onboard power conversion module that is adapted to convert AC inputs to DC outputs that can be accepted by the traction battery pack 12. DC fast charging refers to charging events in which power levels of about 50 kW or more are delivered for rapidly charging the battery cells 18 of the traction battery pack 12. In this disclosure, the term “about” means that the expressed quantities or ranges need not be exact but may be approximated and/or larger or smaller, reflecting acceptable tolerances, conversion factors, measurement error, etc.

DC fast charging is considered to be a more aggressive type of charging compared to Level 1 and Level 2 charging. Although faster and in many cases more convenient, repeated DC fast charging events can reduce the cycle life of the battery cells 18 of the traction battery pack 12. Moreover, for lithium-ion battery cells, gas generation and swelling are common consequences of repetitive charging and discharging operations. Applying a compression force to the battery cells 18 during charging events can mitigate the effects of gas generation and swelling and thereby extend cycle life. This disclosure is therefore directed to battery charging systems and methods designed to influence battery cell life cycles by varying the compression force applied to the battery cells 18 during charging events.

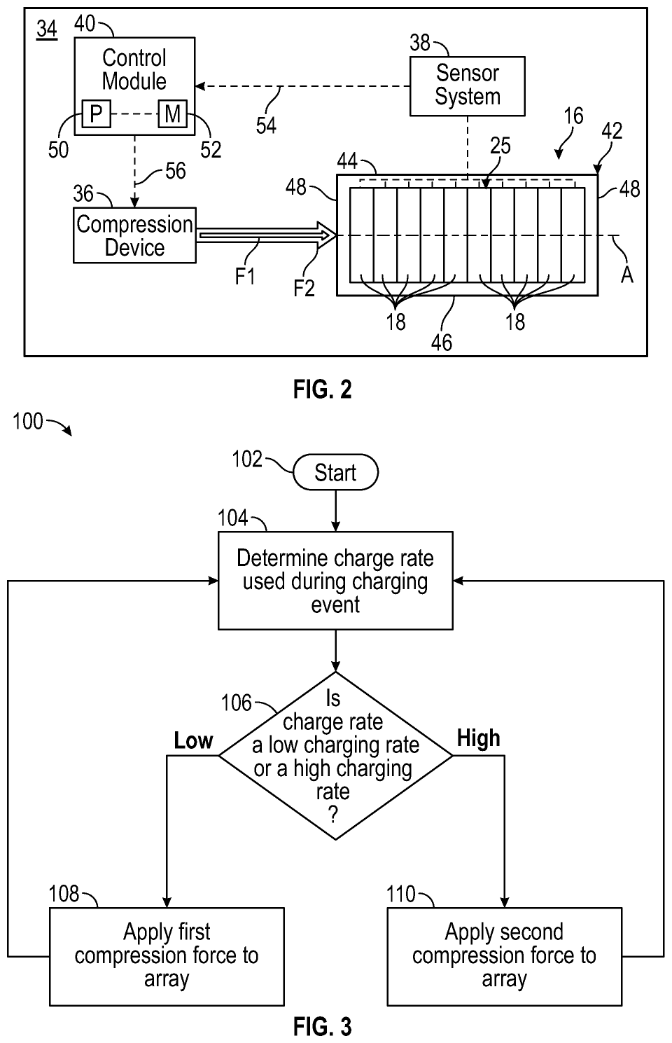

FIG. 2 is a highly schematic depiction of a battery charging system 34 that could be implemented on the electrified vehicle 10 or any other electrified vehicle. The battery charging system 34 may be configured to vary the compression force applied to a battery array 16 of a traction battery pack 12 during charging events in order to positively influence the cycle life of the battery cells 18 of the battery array 16.

A single battery array 16 is shown in FIG. 2 for simplicity. However, it should be recognized that the battery charging system 34 could be configured to vary the compression force applied to one or more battery arrays 16.

In an embodiment, the battery charging system 34 may vary the compression force applied to the battery array 16 (and thus to the battery cells 18) by applying a first compression force F1 during low charging rate conditions (e.g., Level 1 or Level 2 charging conditions) and by applying a second, different compression force F2 to the battery array 16 during high charging rate conditions (e.g., DC fast charging conditions). In general, a C-rate of 1C or lower may be utilized to charge during low charging rate conditions, and a C-rate of greater than 1C may be utilized to charge during high charging rate conditions.

The battery charging system 34 may include one or more battery arrays 16, a compression device 36, a sensor system 38, and a control module 40. Each battery array 16 may include a plurality of battery cells 18. The battery array 16 could employ any number of battery cells 18. The battery cells 18 may be stacked together along a longitudinal axis A to establish a cell stack 25 of the battery array 16.

In an embodiment, the battery cells 18 are lithium-ion cells. However, other cell chemistries (nickel-metal hydride, solid state batteries, lithium-metal batteries, etc.) could alternatively be utilized within the scope of this disclosure.

In another embodiment, the battery cells 18 are prismatic or pouch battery cells. However, other cell geometries could alternatively be utilized within the scope of this disclosure.

A support structure 42 of the battery array 16 may substantially surround the cell stack 25. In an embodiment, the support structure 42 completely encloses the cell stack 25. In some implementations, the support structure 42 may include a top plate 44, a bottom plate 46, a pair of end plates 48, and a pair of side plates (not shown in the schematic depiction of FIG. 2).

The compression device 36 may be configured to selectively apply a compression force of an optimal value to the battery array 16 during charging events. In an embodiment, the compression force may be applied along the direction of the longitudinal axis A of the cell stack 25 of the battery array 16. However, the compression force could alternatively or additionally be applied in a direction that is transverse to the longitudinal axis A. In another embodiment, the compression force is applied perpendicular to planar surfaces of electrode layers within each battery cell 18 of the cell stack 25. In another embodiment, the compression force is applied both along the longitudinal axis A and in a direction that is transverse to the longitudinal axis A, with the transverse compression force being lower than the longitudinal compression force. In yet another embodiment, the compression device 36 may interface with portions of the support structure 42 for applying the compression force.

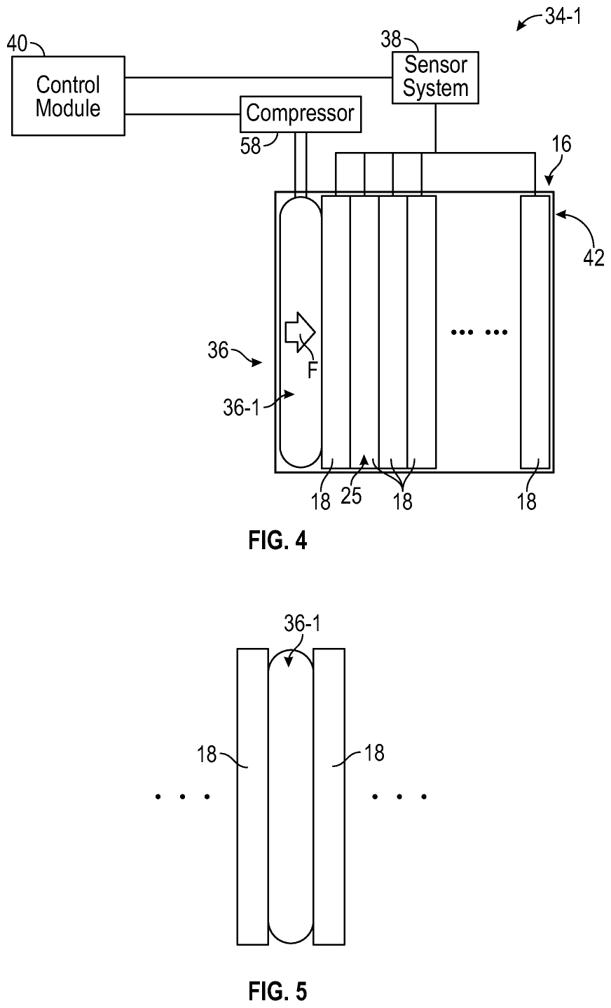

The compression device 36 may be any device capable of mechanically applying the compression force during charging events. Examples of suitable compression devices 36 include but are not limited to air bladders, air cylinders, hydraulic cylinders, motor actuated threaded shaft rods, shape memory alloy structures, etc. (see, e.g., specification implementations of FIGS. 4-14).

The sensor system 38 may be configured to sense various operating conditions associated with the battery array 16, and in particular, parameters associated with the battery cells 18. In an embodiment, the sensor system 38 may include one or more sensors that are operably linked to each battery cell 18 of the battery array 16 and that are configured to sense one or more operating conditions associated with each respective battery cell 18. In an embodiment, the sensor system 38 monitors the charge rate the battery cells 18 are charged at during charging events. In an embodiment, the sensor system 38 is part of a battery management system (BMS) capable of monitoring each individual battery cell 18 of the battery array 16.

The control module 40 may be operably connected to both the compression device 36 and the sensor system 38. The control module 40 may include both hardware and software and could be part of either the electrified vehicle 10, the EVSE system 22, or both. Thus, although shown as a single controller, the control module 40 could include multiple control units that can communicate with one another for controlling the battery charging system 34. In an embodiment, the control module 40 is programmed with executable instructions for interfacing with and commanding operations of the various subcomponents of the battery charging system 34.

The control module 40 may include a processor 50 and non-transitory memory 52 for executing the various control strategies and modes associated with the battery charging system 34. The processor 50 can be a custom made or commercially available processor, a central processing unit (CPU), or generally any device for executing software instructions. The memory 52 may include any one or combination of volatile memory elements and/or nonvolatile memory elements.

The processor 50 may be operably coupled to the memory 52 and may be configured to execute one or more programs stored in the memory 52 of the control module 40 based on various inputs received from other devices, such as inputs from the sensor system 38. For example, the sensor system 38 may be designed to periodically communicate a signal 54 to the control module 40 during charging events. The signal 54 may include information associated with the battery array 16, such as the charge rate being used to charge the battery cells 18 during the charging event, for example. In response to receiving the signal 54, the control module 40 may command (e.g., by communicating a control signal 56) activation of the compression device 36. The compression device 36 may then apply the appropriate compression force to the cell stack 25 of the battery array 16.

The control module 40 may further be programmed to dynamically vary the compression force when the charge rate indicated by the signal 54 changes. For example, the control module 40 may command the compression device 36 to apply a first compression force F1 when the charge rate indicates a low charge rate condition and may further command the compression device 36 to apply a second, greater compression force F2 when the charge rate indicates a high charge rate condition. In an embodiment, the appropriate compression force to apply for any given charge rate may be stored in the memory 52 of the control module 40, such as within one or more look-up tables. In another embodiment, the one or more look-up tables may include battery-related parameters such as temperature, start-of-charge (SOC), and battery age and/or internal resistance dependency for determining the appropriate compression force to apply for a given situation.

In an embodiment, the first compression force F1 is a force between about 15 psi and about 20 psi, or between about 16 psi and about 18 psi, or is about 16 psi. In another embodiment, the second compression force F2 is a force between about 20 psi and about 30 psi, or between about 24 psi and about 28 psi, or is about 26 psi. In another embodiment, the second compression force F2 is between about 50% and about 100% greater than the first compression force F1.

However, the actual compression force applied to the cells stack 25 during both low rate charging conditions and high rate charging conditions may ultimately vary depending on factors such as the size and chemistry type of the battery cells 18. For example, solid state batteries may require a much larger compression force (e.g., up to 100 times larger) compared to liquid electrolyte batteries at both high and low charging rates, and silicone anode batteries may require higher compression forces to alleviate the volume change of the silicone anode during charging. Still other cell chemistries could require lower compression forces during high rate charging than those required during low rate charging. Therefore, for the purposes of this disclosure, the compression forces F1 and F2 could each be any number between about 5 psi and about 15,000 psi.

In an embodiment, the optimal compression force to be applied to a given battery cell/array for a given charge rate may be calculated by applying a multitude of compression forces over a plurality of cycles and then determining which force provides the greatest charge capacity retention over the given number of cycles. However, other methodologies could alternatively or additionally be used.

FIG. 3, with continued reference to FIGS. 1-2, schematically illustrate in flow chart form an exemplary method 100 for controlling the battery charging system 34 during a charging event. The battery charging system 34 may be configured to employ one or more algorithms adapted to execute at least a portion of the steps of the exemplary method 100. For example, the method 100 may be stored as executable instructions in the memory 52 of the control module 40, and the executable instructions may be embodied within any computer readable medium that can be executed by the processor 50 of the control module 40.

The exemplary method 100 may begin at block 102. At block 104, the method 100 may determine the charge rate being used to charge the battery cells 18 of the battery array 16 during a given charging event. The method 100 may then, at block 106, determine whether the charging rate indicates a low charging rate condition or a high charging rate condition. This step may include searching one or more look-up tables for the corresponding optimal compression force for a given charge C-rate. The method 100 may then proceed to either block 108 or 110 by applying the corresponding compression force to the battery array 16 (e.g., if low, apply a first compression force at block 108, or if high, apply a second, greater compression force at block 110). The method 100 may then return to block 104 (from either block 108 or 110) as part of a closed loop system for continuously altering the compression force to best suit the current charge rate conditions being utilized when charging the battery cells 18.

FIGS. 4-14 schematically illustrate various potential implementations for providing a battery charging system capable of altering the compression force applied to a battery array 16 during charging events in order to influence the cycle life of the battery cells 18 of the battery array 16. Other implementations than those depicted in FIGS. 4-14 could be recognized by persons of ordinary skill in the art and are therefore contemplated within the scope of this disclosure.

FIG. 4 illustrates a battery charging system 34-1 in which the compression device 36 includes an air bladder 36-1 arranged to apply compression forces to the battery array 16. In an embodiment, the air bladder 36-1 is arranged between a portion of the support structure 42 and the cell stack 25. In another embodiment, the air bladder 36-1 is arranged between adjacent battery cells 18 of the cell stack 25 (see FIG. 5).

In use, the sensor system 38 may communicate parameters such as charge rate information to the control module 40 during charging events. In response to receiving the charge rate information, the control module 40 may command a compressor 58 to either inflate the air bladder 36-1 to increase a compression force F or deflate the air bladder 36-1 to reduce the compression force F. The control module 40 may be configured to automatically vary the compression force F as the charge rate sensed by the sensor system 38 changes.

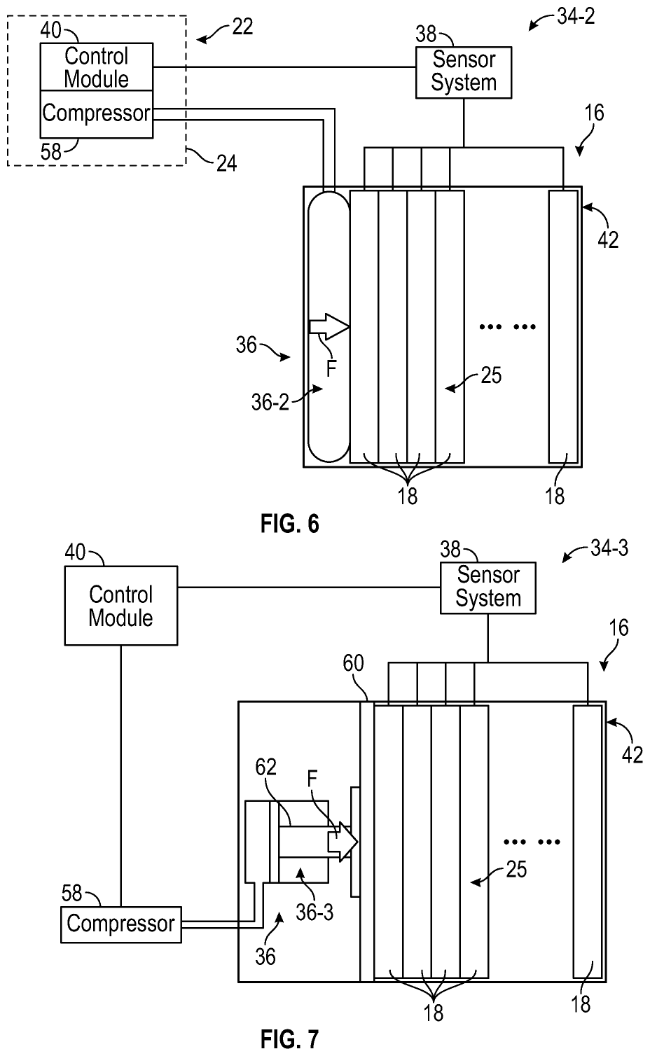

FIG. 6 illustrates another exemplary battery charging system 34-2. The battery charging system 34-2 is similar to the battery charging system 34-1 of FIG. 4 and may include an air bladder 36-2 as part of the compression device 36. However, in the implementation of FIG. 4, the control module 40 and the compressor 58 are components of the electrified vehicle 10, whereas in the implementation of FIG. 6, the control module 40 and the compressor 58 may be components housed within the EVSE housing 24 of the EVSE system 22. In such an implementation, compressed air from the compressor 58 may be transferred from the EVSE housing 24 to the air bladder 36-2 (e.g., via the charge port assembly 32 and the charge cord assembly 26).

FIG. 7 illustrates a battery charging system 34-3 in which the compression device 36 includes an air cylinder 36-3 arranged to apply compression forces to the battery array 16. In an embodiment, the air cylinder 36-3 is arranged between a portion of the support structure 42 and the cell stack 25 and may apply the compression forces directly to one of the battery cells 18 or to a flat plate 60 located between the air cylinder 36-3 and the cell stack 25.

In use, the sensor system 38 may communicate parameters such as charge rate information to the control module 40 during charging events. In response to receiving the charge rate information, the control module 40 may command a compressor 58 to either extend a piston 62 of the air cylinder 36-3 to increase a compression force F or retract the piston 62 of the air cylinder 36-3 to reduce the compression force F. The control module 40 may be configured to automatically vary the compression force F as the charge rate sensed by the sensor system 38 changes.

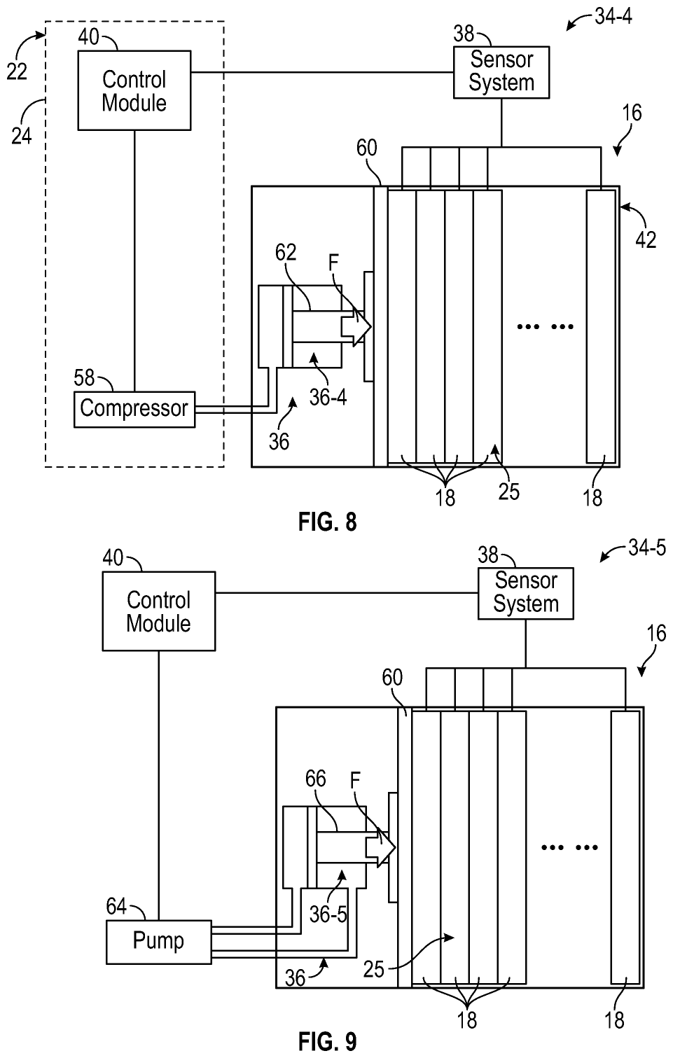

FIG. 8 illustrates another exemplary battery charging system 34-4. The battery charging system 34-4 is similar to the battery charging system 34-3 of FIG. 7 and may include an air cylinder 36-4 as part of the compression device 36. However, in the implementation of FIG. 7, the control module 40 and the compressor 58 are components of the electrified vehicle 10, whereas in the implementation of FIG. 8, the control module 40 and the compressor 58 may be components housed within the EVSE housing 24 of the EVSE system 22. In such an implementation, compressed air from the compressor 58 may be transferred from the EVSE housing 24 to the air cylinder 36-4 (e.g., via the charge port assembly 32 and the charge cord assembly 26).

FIG. 9 illustrates a battery charging system 34-5 in which the compression device 36 includes a hydraulic cylinder 36-5 arranged to apply compression forces to the battery array 16. In an embodiment, the hydraulic cylinder 36-5 is arranged between a portion of the support structure 42 and the cell stack 25 and may apply the compression forces directly to one of the battery cells 18 or to a flat plate 60 located between the hydraulic cylinder 36-5 and the cell stack 25.

In use, the sensor system 38 may communicate parameters such as charge rate information to the control module 40 during charging events. In response to receiving the charge rate information, the control module 40 may command a pump 64 to supply a fluid to the hydraulic cylinder 36-5 to either extend a piston 66 of the hydraulic cylinder 36-5 to increase a compression force F or retract the piston 66 of the hydraulic cylinder 36-5 to reduce the compression force F. The control module 40 may be configured to automatically vary the compression force F as the charge rate changes.

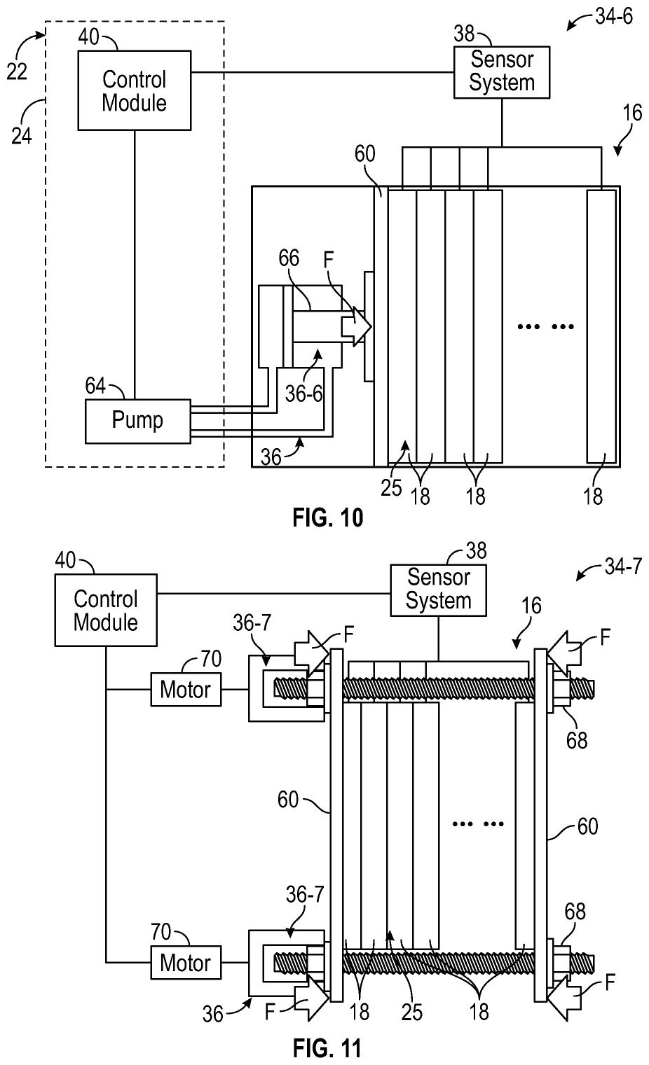

FIG. 10 illustrates another exemplary battery charging system 34-6. The battery charging system 34-6 is similar to the battery charging system 34-5 of FIG. 9 and may include a hydraulic cylinder 36-6 as part of the compression device 36. However, in the implementation of FIG. 9, the control module 40 and the pump 64 are components of the electrified vehicle 10, whereas in the implementation of FIG. 10, the control module 40 and the pump 64 may be components housed within the EVSE housing 24 of the EVSE system 22. In such an implementation, fluid from the pump 64 may be transferred from the EVSE housing 24 to the hydraulic cylinder 36-6 (e.g., via the charge port assembly 32 and the charge cord assembly 26).

FIG. 11 illustrates a battery charging system 34-7 in which the compression device 36 includes one or more screw shaft rods 36-7 arranged to apply compression forces to the battery array 16. Each screw shaft rod 36-7 may be secured to the battery array 16 via a nut 68. The screw shaft rods 36-7 may apply the compression forces to flat plates 60 that flank the battery cells 18 of the cell stack 25.

In use, the sensor system 38 may communicate parameters such as charge rate information to the control module 40 during charging events. In response to receiving the charge rate information, the control module 40 may command a motor 70 associated with each screw shaft rod 36-7 to rotate the screw shaft rod 36-7 in a first direction to increase a compression force F, or to rotate the screw shaft rod 36-7 in a second direction to reduce the compression force F. The control module 40 may be configured to automatically vary the compression force F as the charge rate changes.

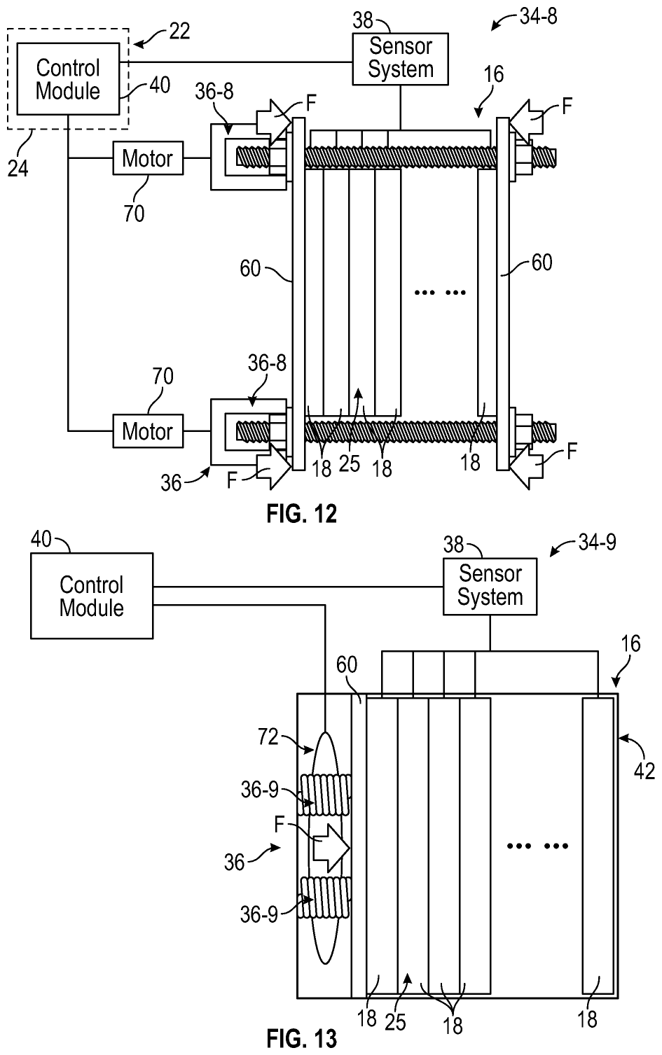

FIG. 12 illustrates another exemplary battery charging system 34-8. The battery charging system 34-8 is similar to the battery charging system 34-7 of FIG. 11 and may include one or more screw shaft rods 36-7 as part of the compression device 36. However, in the implementation of FIG. 11, the control module 40 is a component of the electrified vehicle 10, whereas in the implementation of FIG. 12, the control module 40 may be a component housed within the EVSE housing 24 of the EVSE system 22.

FIG. 13 illustrates a battery charging system 34-9 in which the compression device 36 includes one or more shape memory alloy structures 36-9 arranged to apply compression forces to the battery array 16. In an embodiment, the shape memory alloy structures 36-9 are spring-like coiled structures. However, other implementations are also possible.

Each shape memory alloy structure 36-9 may be secured between a portion of the support structure 42 and the cell stack 25 and may apply the compression forces directly to one of the battery cells 18 or to a flat plate 60 located between the shape memory alloy structures 36-9 and the cell stack 25.

In use, the sensor system 38 may communicate parameters such as charge rate information to the control module 40 during charging events. In response to receiving the charge rate information, the control module 40 may command a heating element 72 to heat the shape memory alloy structures 36-9, thereby causing them to change shape (e.g., lengthen). Lengthening the shape memory alloy structures 36-9 may increase a compression force F, and shortening the shape memory alloy structures 36-9 (e.g., by reducing or eliminating the heat) may reduce the compression force F. The control module 40 may be configured to automatically vary the compression force F as the charge rate changes.

The heating element 72 may be housed within or adjacent to the battery array 16. However, other implementations could also be possible.

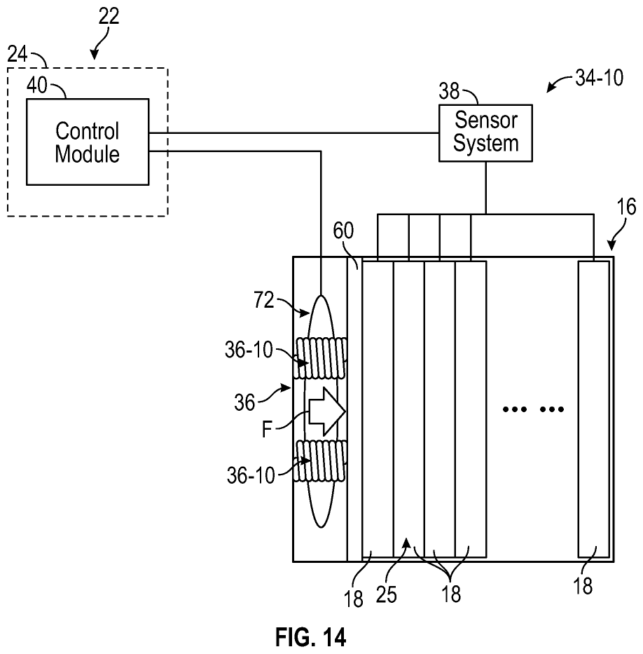

FIG. 14 illustrates another exemplary battery charging system 34-10. The battery charging system 34-10 is similar to the battery charging system 34-9 of FIG. 13 and may include one or more shape memory alloy structures 36-10 as part of the compression device 36. However, in the implementation of FIG. 12, the control module 40 is a component of the electrified vehicle 10, whereas in the implementation of FIG. 14, the control module 40 may be a component housed within the EVSE housing 24 of the EVSE system 22.

The battery charging systems of this disclosure are configured to dynamically vary an amount of compressive force applied to battery cells based on a charge rate. Optimizing the compressive force based on charge rate can positively influence the cycle life of battery cells.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery charging system, comprising:
a battery array;
a compression device configured to apply a compression force to the battery array during a charging event; and
a control module programmed to control the compression device to apply a first compression force during a low charging rate condition and to apply a second, different compression force during a high charging rate condition.

2. The battery charging system as recited in claim 1, wherein the low charging rate condition includes a Level 1 or Level 2 charging condition and the high charging rate condition includes a DC fast charging condition.

3. The battery charging system as recited in claim 1, wherein the second, different compression force is a larger compression force than the first compression force.

4. The battery charging system as recited in claim 1, wherein the second, different compression force is a smaller compression force than the first compression force.

5. The battery charging system as recited in claim 1, wherein the compression device includes an air bladder.

6. The battery charging system as recited in claim 1, wherein the compression device includes an air cylinder or a hydraulic cylinder.

7. The battery charging system as recited in claim 1, wherein the compression device includes a motor actuated threaded shaft rod.

8. The battery charging system as recited in claim 1, wherein the compression device includes a shape memory alloy structure.

9. The battery charging system as recited in claim 1, comprising a sensor system operably coupled to the control module and configured to monitor a charge rate during the charging event.

10. The battery charging system as recited in claim 1, wherein the control module is a component of an electrified vehicle that includes the battery charging system.

11. The battery charging system as recited in claim 1, wherein the control module is a component of an electric vehicle supply equipment (EVSE) system.

12. The battery charging system as recited in claim 11, wherein the first compression force and the second compression force are different forces and are each in the range of about 5 psi to about 15,000 psi.

13. A method, comprising:
varying a compression force applied to a battery array of a traction battery pack during a charging event,
wherein varying the compression force incudes applying a first compression force during a low charging rate condition and applying a second, different compression force during a high charging rate condition.

14. The method as recited in claim 13, wherein the low charging rate condition includes a Level 1 or Level 2 charging condition and the high charging rate condition includes a DC fast charging condition.

15. The method as recited in claim 13, wherein the second, different compression force is a larger compression force than the first compression force.

16. The method as recited in claim 13, wherein the second, different compression force is a smaller compression force than the first compression force.

17. The method as recited in claim 13, wherein varying the compression force includes inflating or deflating an air bladder of a compression device.

18. The method as recited in claim 13, wherein varying the compression force includes extending or retracting a piston of an air cylinder or a hydraulic cylinder of a compression device.

19. The method as recited in claim 13, wherein varying the compression force includes rotating a screw shaft rod of a compression device. The method as recited in claim 13, wherein varying the compression force includes altering a shape of a shape memory alloy structure of a compression device.
